(19) United States
(12) Patent Application Publication
(10) Pub. No.: US 2026/0093426 A1
(43) Pub. Date: Apr. 2, 2026

(54) DEVICE MANAGEMENT SYSTEM, IMAGE FORMING APPARATUS, AND DEVICE MANAGEMENT METHOD

(71) Applicant: SHARP KABUSHIKI KAISHA, Osaka (JP)

(72) Inventor: YOSHIKAZU KONDOH, Osaka (JP)

(21) Appl. No.: 19/339,755

(22) Filed: Sep. 25, 2025

(30) Foreign Application Priority Data
Oct. 2, 2024 (JP) 2024-173413

(51) Int. Cl. G06F 3/12; H04L 67/51

(52) U.S. Cl. CPC G06F 3/1231; G06F 3/1204; G06F 3/1236; H04L 67/51; G06F 3/1286

(57) ABSTRACT

A device management system including one or a plurality of first devices and a second device that manages the one or the plurality of first devices, in which the first device transmits device information for identifying the first device to the second device via a common connection destination, and the second device connects to the first device when the device information is stored.

### TECHNICAL FIELD

The disclosure relates to a device management system and the like. The present application claims priority from Japanese Application JP2024-173413, the content of which is hereby incorporated by reference into this application.

### BACKGROUND

In the related art, a device management device has been disclosed that receives device information including device identification information for identifying a device itself, the device information being transmitted from the device via a predetermined data transmission path, refers to device matching information including a device identification item for matching a registered device retained by the device based on the received device information, and determines whether the device that transmitted the device information is a registered device.

### SUMMARY

One of the objects of the disclosure is, for example, to implement a system capable of executing registration in a management system at an arbitrary timing by accessing a common connection destination, and to reduce management, introduction, and initial installation costs.

A device management system of the disclosure includes one or a plurality of first devices, and a second device that manages the one or the plurality of first devices, in which the first device transmits device information for identifying the first device to the second device via a common connection destination, and the second device connects to the first device when the device information is stored.

An image forming apparatus of the disclosure includes a communicator that transmits device information to a management device as a common connection destination, an acquirer that acquires setting information and management policy information based on customer information from the management device, and an initial setting executor that executes an initial setting based on the setting information and the management policy information.

A device management method of the disclosure is a device management method for a system including one or a plurality of first devices, and a second device that manages the one or the plurality of first devices, the method including a transmission step in which the first device transmits device information for identifying the first device to the second device via a common connection destination, and a connection step in which the second device connects to the first device when the device information is stored.

### ADVANTAGEOUS EFFECTS OF DISCLOSURE

According to the disclosure, for example, it is possible to provide a device management system that can implement a system capable of executing registration in a management system at an arbitrary timing by accessing a common connection destination, and can reduce a management cost and an introduction cost of a user and reduce an initial installation cost of a service.

### BRIEF DESCRIPTION OF DRAWINGS

FIG. 1 is a diagram for illustrating an overview of a system according to a first embodiment.

FIG. 2 is a diagram illustrating a configuration of hardware of the system according to the first embodiment.

FIG. 3 is a diagram illustrating the configuration of the hardware of the system according to the first embodiment.

FIGS. 4A and 4B are diagrams illustrating a configuration of software of the system according to the first embodiment.

FIGS. 5A and 5B are diagrams illustrating the configuration of the software of the system according to the first embodiment.

FIG. 6A is a diagram illustrating an example of management information and FIG. 6B is a diagram illustrating an example of sales information in the first embodiment.

FIG. 7 is a diagram illustrating a flow of processing according to the first embodiment.

FIG. 8 is a diagram illustrating the flow of processing according to the first embodiment.

FIG. 9 is a diagram illustrating the flow of processing according to the first embodiment.

FIG. 10 is a diagram illustrating the flow of processing according to the first embodiment.

FIG. 11A is a diagram illustrating an example of a display screen in initial setting and FIG. 11B is a diagram illustrating an example of a display screen displaying unregistered device information as an operation example in the first embodiment.

### DESCRIPTION OF EMBODIMENTS

In general, in a system that manages a plurality of devices over a network, a user or a serviceman inputs connection destination information that is individually issued at the time of installation, and connects the device. Further, a time limit is set for the connection destination information from the viewpoint of security, and even in a case where it is set in advance on the device side, in a case where installation is performed at a timing beyond the validity period due to the user's circumstances, there has been a problem in that registration in the device management system cannot be performed.

Further, normally, the system merely recognizes the connected device, and initial settings and management policies for each user (tenant) need to be set after confirming the device to be used after the connection. In this way, in a case where the device directly communicates with the cloud (system), it is necessary to specify information such as which user and which tenant to connect to at the time of installation, and thus work by the user or serviceman is required during installation, resulting in issues such as management costs and introduction costs.

A device management system for solving such problems will be described below in embodiments with reference to the drawings. It is to be noted that the embodiments described below are merely examples for explaining the disclosure described in the claims, and the technical scope of the disclosure is not limited to the descriptions of these embodiments.

### 1. First Embodiment

### 1. 1 Regarding System

### 1. 1. 1. Overview of System

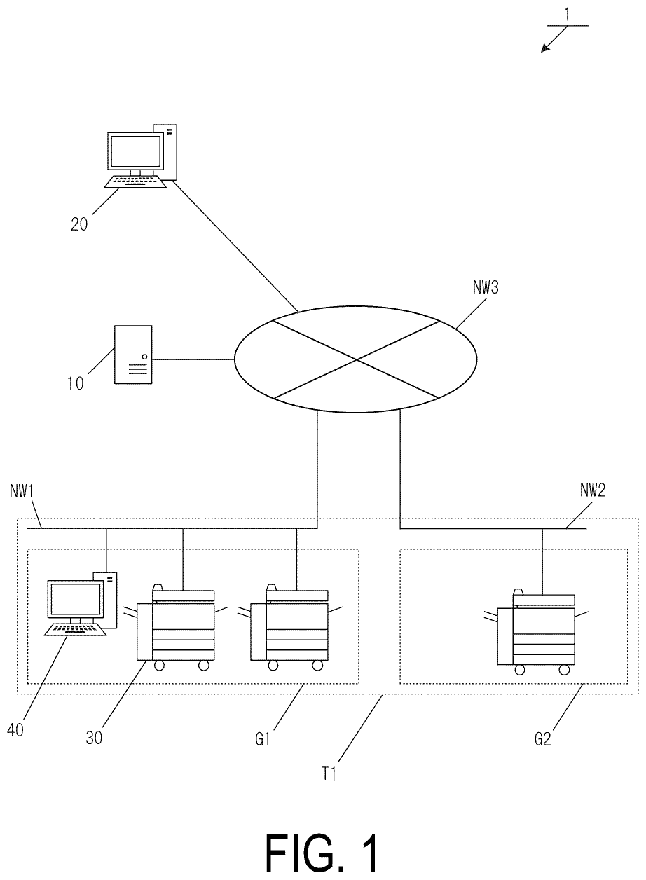

FIG. 1 is a diagram illustrating an overview of a system 1. The system 1 includes a management device (second device) 10, and is connected to a network (NW1, NW2, NW3). The management device 10 registers, for example, one or a plurality of devices connected to the network (NW1, NW2, NW3) as management target devices (first devices). Here, the management target device is a device to be managed, and is, for example, a device that manages settings and the like necessary for the operation of the device by the management device 10.

In addition, the system 1 may include an administrator device (third device) 20. The administrator device 20 is connected to, for example, the network NW3. The administrator device 20 can connect to the management device 10 and designate a management target device managed by the management device 10, for example.

Furthermore, the system 1 may further include an image forming apparatus 30. The image forming apparatus 30 is, for example, a multifunction peripheral or a device called an MFP. For example, when executing a job (print job), the image forming apparatus 30 can form an image on a sheet that is a recording medium. The image forming apparatus 30 can execute a job for a plurality of processing operations such as copy processing, FAX processing, scan processing, and print processing, as a job to be executed.

In the present embodiment, the image forming apparatus 30 is a management target device. The image forming apparatus 30 may be connected to the management device 10 via a network (NW1, NW3) as a management target device, for example. In addition to the image forming apparatus, the management target device may be, for example, an information processing apparatus such as a smartphone or a tablet. In addition, the device may be a home appliance equipped with IoT functions (for example, an air conditioner, a refrigerator, a television, and the like), or may be a portable device or an in-vehicle device (for example, a car navigation system, and the like).

In addition, the system 1 may include a terminal device 40 and the terminal device 40 is connected to, for example, a network (NW1, NW3). The terminal device 40 intermediates communication between the management target device and the management device 10, and, for example, can acquire device information or the like from the image forming apparatus 30 and transmit the device information or the like to the management device 10. The terminal device 40 can also intermediate communication, for example, between a plurality of management target devices and the management device 10.

The management device 10 may be, for example, an information processing apparatus such as a server device. The administrator device 20 may be, for example, an information processing apparatus such as a terminal device.

In addition, the system 1 also includes a tenant T1. The tenant T1 is configured by, for example, devices connected to networks (NW1, NW2), and includes a group G1 and a group G2. The tenant and the group will be described later.

### 1. 1. 2 Terms

Hereinafter, the terms in the present specification are used in the context of the meaning of the range that can be understood by those skilled in the art, and for example, the terms are as follows.

The “tenant” is a unit for managing the device in the present system. The management target device is registered in the system 1 in association with (being linked with) the tenant. The tenant may be set, for example, for each customer, such as for each individual, each company, or each organization, on a user basis. In the present system, for example, initial settings and management policies to be applied to a device can be set in association with each tenant, and the initial settings and management policies can be collectively applied to devices linked to the tenant.

The “group” refers to a unit for managing devices in the present system, and is a management unit obtained by subdividing a tenant. For example, the tenant may be composed of a plurality of groups, and the group may further be composed of a plurality of groups. The group can be freely set in a unit of each network (NW1, NW2), a unit of each service type, a unit of each department, or the like. In a tenant in which groups are set, for example, initial settings and management policies to be applied to devices can be associated and set on a tenant basis for each group, and can be applied to devices associated with each group in the same manner as with the tenant.

The “management policy” refers to a management rule to be applied to a device, and may include, for example, rules for managing access rights and service usage rights. The management policies may include, for example, a patch policy, an access control policy, a service control policy, and the like.

The “device information” is information for identifying a device, and includes, for example, a serial number and a model name. In addition, the device information may include additional information other than the information for identifying the device. For example, the information additionally included may include information on the tenant of the purchaser linked to the device information, information on the group as the installation destination, and management policy information to be applied to the device.

The “common connection destination” is a connection destination of the management device 10, and may be, for example, a uniform resource locator (URL) for connecting to the management device 10. The common connection destination is, for example, a connection destination that does not need to be set for each tenant, does not need to issue a connectable URL each time, and does not have a time limit required for access.

The “user administrator” is an administrator who operates and installs the management target device (in the present embodiment, the image forming apparatus 30) and the terminal device 40, and manages the management target device. The user administrator may be, for example, a personal user, an employee belonging to a tenant, or a serviceman who performs management in response to a request from a tenant.

The “system administrator” is an administrator who manages the system 1 and operates the administrator device 20. The system administrator may be, for example, an employee or a serviceman belonging to a store, and may be the same as the user administrator in a case where the system administrator performs management in response to a request from a tenant.

### 1. 2 Hardware Configuration

### 1. 2. 1 Common Configuration

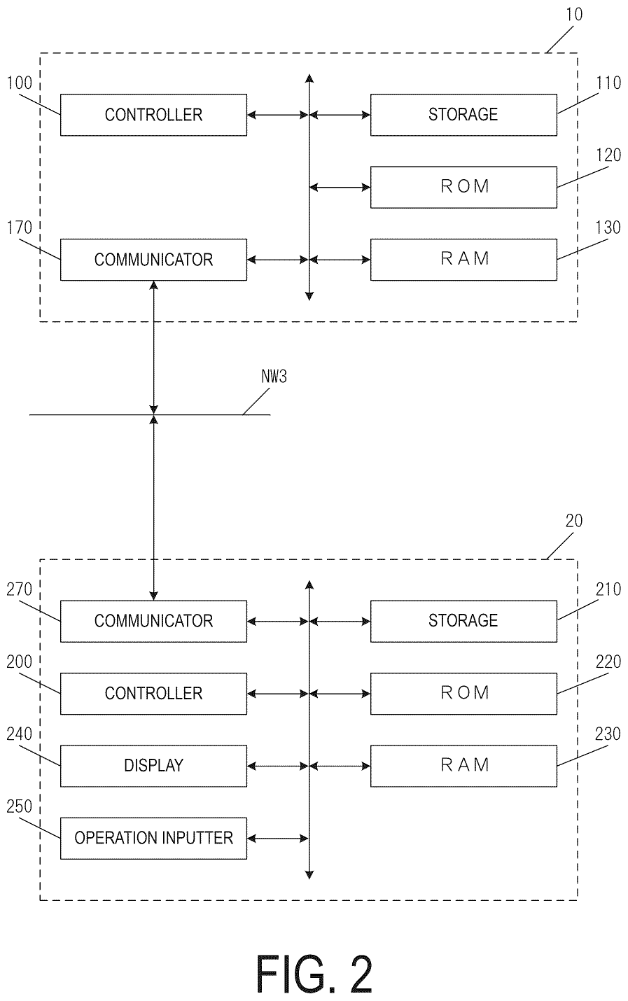

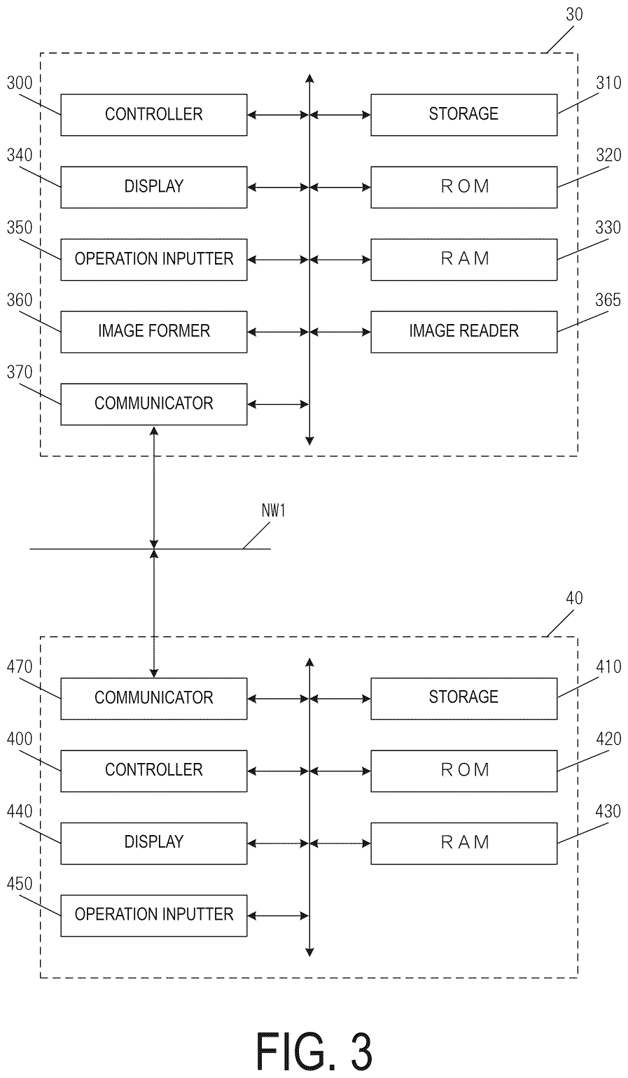

FIGS. 2 and 3 are diagrams illustrating a hardware configuration of each device in the present embodiment. Each of the management device 10, the administrator device 20, the image forming apparatus 30, and the terminal device 40 includes at least a controller, a storage unit (a storage, a read only memory (ROM), and a random access memory (RAM)), and a communicator. In addition, each of the devices has a general function as necessary.

Here, among the respective devices, a controller, a storage, a ROM, a RAM, a display, an operation inputter, and a communicator will be described below.

The controller (for example, a controller 100, a controller 200, a controller 300, and a controller 400) is a functional unit for controlling the entire device. The controller implements various functions by reading and executing various programs stored in a storage or the ROM. The controller may be implemented by one or a plurality of control devices/arithmetic devices (central processing unit (CPU) or system on a chip (SoC)). In addition, the controller may include one or a plurality of control circuits.

The storage (for example, a storage 110, a storage 210, a storage 310, and a storage 410) is a non-volatile storage device capable of storing programs and data. For example, the storage may be configured of a storage device such as a Hard Disk Drive (HDD) or a Solid Status Drive (SSD). In addition, the storage may also have a configuration such as a Universal Serial Bus (USB) memory that can be connected externally. In addition, the storage may be, for example, a storage area on a cloud.

The ROM (for example, a ROM 120, a ROM 220, a ROM 320, and a ROM 420) is non-volatile memory capable of retaining programs and data even when the power is turned off. The ROM may store, for example, firmware of each device, an initial application, and the like.

The RAM (for example, a RAM 130, a RAM 230, a RAM 330, and a RAM 430) is the main memory mainly used by the controller of each device when executing processing. The RAM is a rewritable memory that temporarily holds a program read from the storage of each device or the ROM of each device and data including a result of the execution.

The display (for example, a display 240, a display 340, and a display 440) is a display device capable of displaying various types of information and various screens such as an execution screen. The display may be, for example, a display device such as a liquid crystal display (LCD), an organic electro-luminescence (EL) display, or an electrophoresis display. In addition, the display includes an interface to which a display device can be connected. For example, the display may include an external display device connected via a high-definition multimedia interface (HDMI; trade name), a digital visual interface (DVI), or a display port.

The operation inputter (for example, an operator 250, an operation inputter 350, and an operator 450) is an operation device capable of receiving operation input from a user administrator or a system administrator. For example, the operator may be software keys displayed on a touch panel integrated with the display or hardware keys such as operation buttons. In addition, the operation inputter may be an operation device such as a keyboard or a mouse. Furthermore, the operation inputter may also include an interface (For example, USB) to which an operation device can be connected. For example, each device may be connected to different operation devices (keyboard, mouse, and the like) via an interface.

The communicator (for example, a communicator 170, a communicator 270, a communicator 370, and a communicator 470) is a communication interface for communicating with other devices. For example, the communicator may be a network interface connectable to a wireless local area network (LAN), or may be a network interface connectable to Ethernet (trade name) in a wired manner. In addition, the communicator may be a communication device connectable to a mobile communication network such as Long Term Evolution (LTE)/4G/5G/6G.

### 1. 2. 2 Image Forming Apparatus

Next, a configuration of hardware of the image forming apparatus 30 will be described with reference to FIG. 3.

An image former 360 forms an image on, for example, a recording sheet. The image former 360 includes, for example, an image carrier, and forms an image by forming a toner image on the image carrier and transferring the toner image on the image carrier onto the recording sheet. The image former 360 may be configured as an image forming apparatus such as a printer. The image former 360 may electronically form an image as an image file.

An image reader 365 reads out an original document (image) and outputs the document as image data. The image reader 365 may be, for example, a scanner, and may be a reading device using a charge coupled device (CCD), a contact image sensor (CIS), or a complementary metal-oxide-semiconductor (CMOS) image sensor.

### 1. 3 Software Configuration

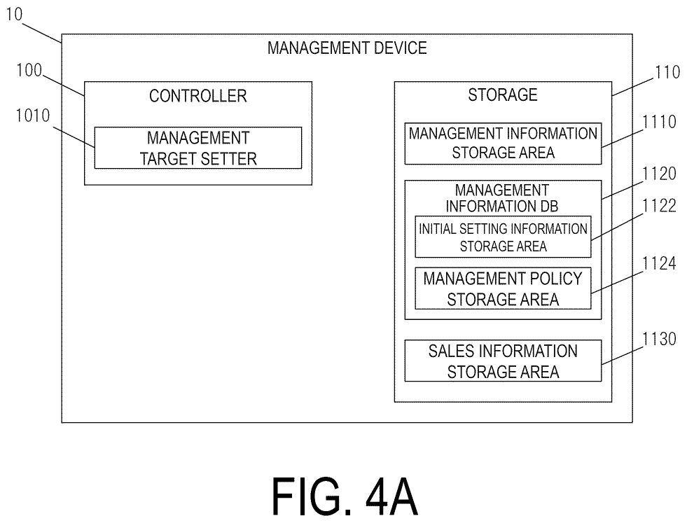

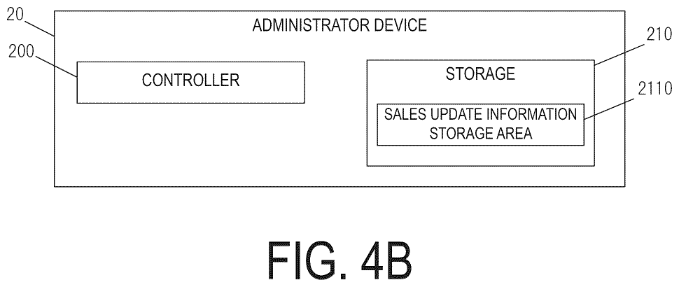

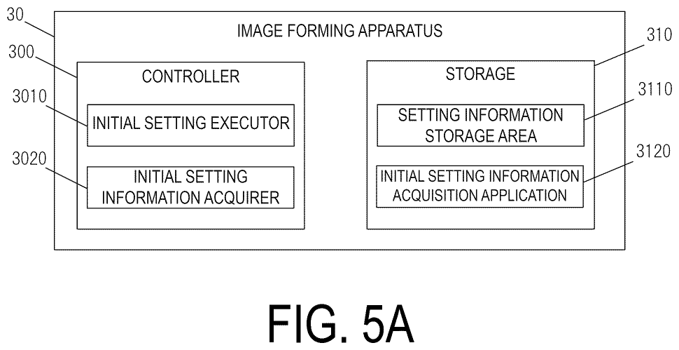

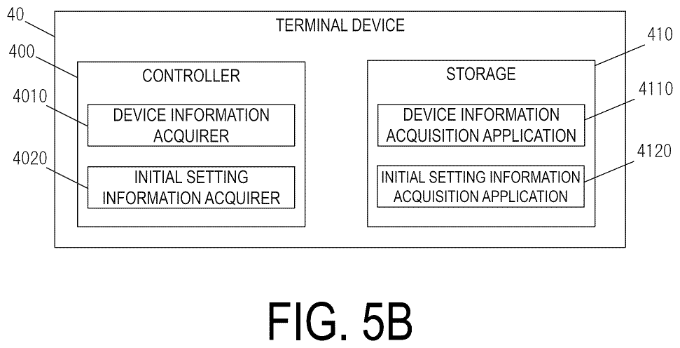

The main software configuration of each device included in the system 1 will be described with reference to FIGS. 4A to 5B. FIG. 4A is a diagram illustrating a configuration of software of the management device 10 and FIG. 4B is a diagram illustrating a configuration of the main software of the administrator device 20. FIG. 5A is a diagram illustrating a configuration of software of the image forming apparatus 30, and FIG. 5B is a diagram for illustrating a configuration of main software of the terminal device 40. Note that the software configuration illustrated in FIG. 4A to FIG. 5B mainly describes configurations necessary for the present embodiment, and other configurations are omitted.

### 1. 3. 1 Management Device

First, the configuration of the main software of the management device 10 will be described. For example, the controller 100 may implement a management target setter 1010 by reading and executing a program stored in a storage unit (the storage 110 and the ROM 120).

The management target setter 1010 transmits, for example, initial setting information or a management policy necessary for initial setting of the management target device managed by the management device to the management target device and sets the initial setting information or the management policy. The management target setter 1010 may transmit, for example, the initial setting information or the management policy, which are acquired from a management information DB 1120, to the management target device based on customer information (such as tenant and group) included in management information stored in a management information storage area 1110.

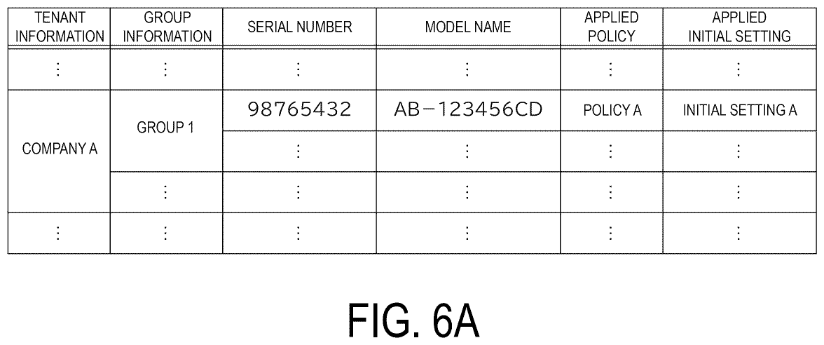

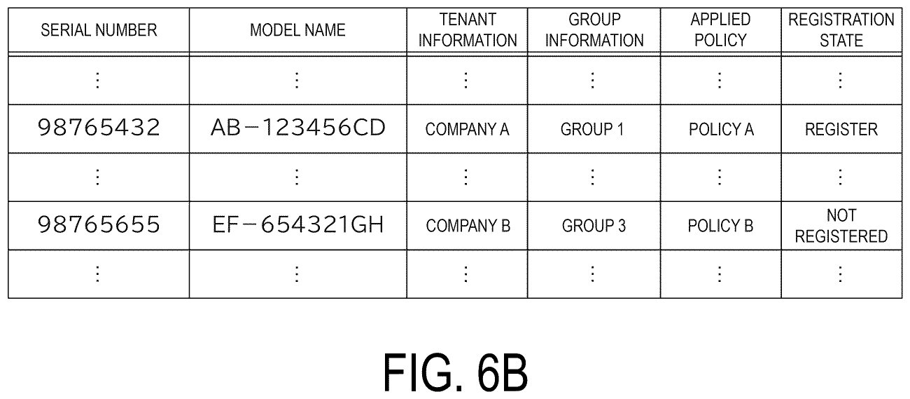

In addition, the storage 110 also secures an area of the management information storage area 1110 for storing management information. The management information (second management information) refers to information for managing the management target device, in which device information for identifying the management target device is associated with customer information such as tenant and group and stored. In addition, the management information may store, for example, setting information or operation information such as initial setting information and management policy information to be applied in association with the customer information. Here, an example of management information stored in the management information storage area 1110 will be described with reference to FIG. 6A. The management information stores tenant information (for example, “Company A”) of the management device 10, group information (for example, “Group 1”), a serial number (for example, “98765432”) of a registered management target device, a model name (for example, “AB-123456CD”), an applied policy (for example, “Policy A”), and applied initial settings (for example, “Initial Setting A”).

In addition, the storage 110 secures an area of the management information DB 1120 that stores an initial setting information storage area 1122 and a management policy storage area 1124. In the initial setting information storage area 1122, settings to be applied to the management target device is stored as initial setting information. In the management policy storage area 1124, a management policy to be applied to the management target device is stored.

In the present embodiment, the initial setting information is information necessary for the initial setting of the management target device; however, it may be used not only for the initial setting but also, for example, for a setting change after the initial setting.

Further, the storage 110 secures an area of a sales information storage area 1130 for storing sales information. The sales information (first management information) is information for managing the management target device by storing device information for identifying the management target device that was sold in correspondence with the tenant of the purchaser and the group to which the device will belong within the tenant of the purchaser. The sales information may also store, for example, setting information and operation information to be applied in association with customer information, and may further include other additional information. Here, an example of the management information stored in the sales information storage area 1130 will be described with reference to FIG. 6B. In the sales information, the serial number (for example, “98765432”) and a model name (for example, “AB-123456CD”) of the sold management target device, the tenant information of the purchaser (for example, “Company A”), the group information to which the device will belong (for example, “Group 1”), the applied policy (for example, “Policy A”), and the registration state (for example, “Registered”) are stored. Here, the registration state is additional information that stores whether the device information on the management target device is registered in the management information, and stores “registered” and “unregistered”.

### 1. 3. 2 Administrator Device

Next, the configuration of the main software of the administrator device 20 will be described.

The storage 210 of the administrator device 20 secures an area of a sales update information storage area 2110 for storing the sales update information. The sales update information is information stored for a tenant of a purchaser of a sold management target device or a group to which the management target device belongs in the tenant of the purchaser, and may be information having the same configuration as the sales information stored in the management device 10 or may be only minimum information for identifying the sold management target device, the tenant of the purchaser, and the like. For example, a difference in sales information may be stored in the sales update information.

### 1. 3. 3 Image Forming Apparatus

Subsequently, the configuration of the main software of the image forming apparatus 30, which is the management target device, will be described. For example, the controller 300 can implement an initial setting executor 3010 and an initial setting information acquirer 3020 by reading and executing a program stored in a storage unit (the storage 310 and the ROM 320).

The initial setting executor 3010 executes initial setting for applying the initial setting information and the management policy acquired from the management device 10 by the initial setting information acquirer 3020 to the image forming apparatus 30. In the present embodiment, the initial setting executor 3010 executes the initial setting; however, can also execute, for example, a change of the setting information after the initial setting.

The initial setting information acquirer 3020 acquires, for example, the initial setting information from the management device 10. Further, for example, in a case where the terminal device 40 is in a network (NW1), the initial setting information acquirer 3020 can acquire the initial setting information and the management policy from the management device 10 via the terminal device 40.

In addition, the storage 310 secures an area of a setting information storage area 3110 for storing the setting information. The setting information is information for storing information necessary for the operation of the image forming apparatus 30 and information on the management policy. In addition, in the setting information, for example, a serial number and a model name as the device information for identifying the management target device, and a URL for connecting to the management device 10 as the common connection destination are stored.

In addition, the storage 310 secures an area for storing an initial setting information acquisition application 3120 for implementing the initial setting information acquirer 3020.

### 1. 3. 4 Terminal Device

Furthermore, a configuration of main software of the terminal device 40 will be described. For example, the controller 400 can implement a device information acquirer 4010 and an initial setting information acquirer 4020 by reading and executing a program stored in a storage unit (the storage 410 and the ROM 420).

The device information acquirer 4010 acquires, for example, device information on a management target device (for example, the image forming apparatus 30) that can be connected on a network (NW1). The device information acquirer 4010 may display the acquired device information on the display 440, and output the selected device information to the initial setting information acquirer 4020 in a case where the user administrator selects the device information, for example.

The initial setting information acquirer 4020 transmits, for example, the device information on the management target device acquired by the device information acquirer 4010 to the management device 10, and acquires the initial setting information from the management device 10. The initial setting information acquirer 4020 can transmit the acquired initial setting information to the initial setting information acquirer 3020 of the corresponding management target device, for example.

In addition, the storage 410 secures an area for storing a device information acquisition application 4110 and an initial setting information acquisition application 4120 for implementing the device information acquirer 4010 and the initial setting information acquirer 4020.

### 1. 4 Flow of Processing

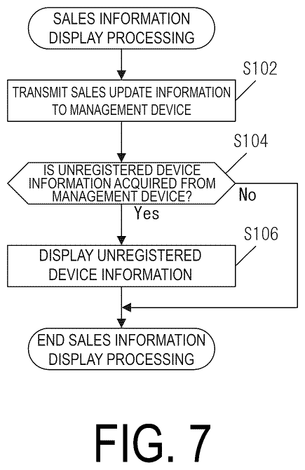

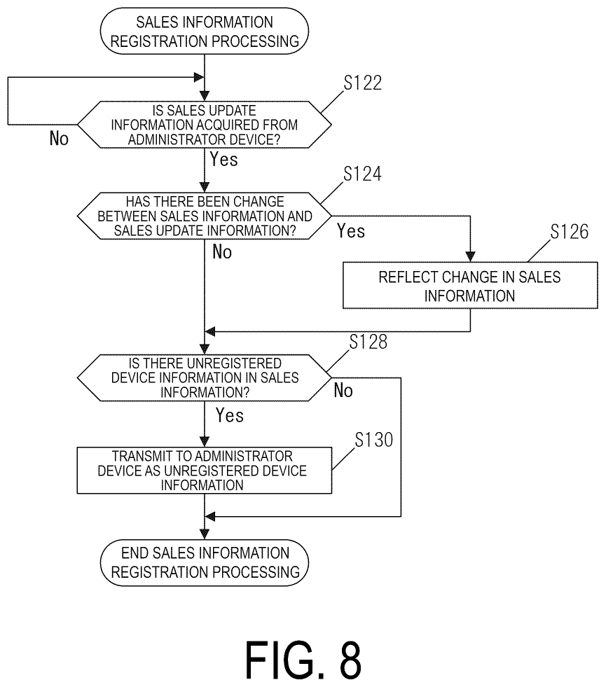

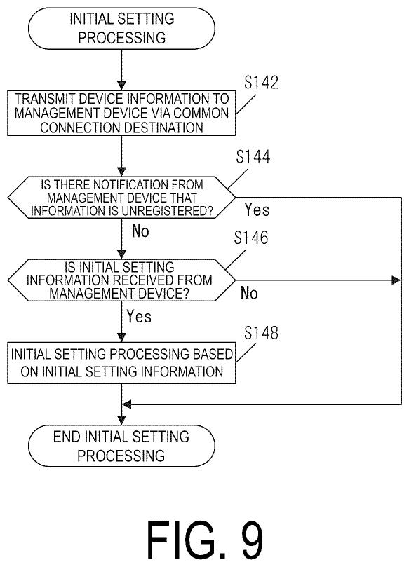

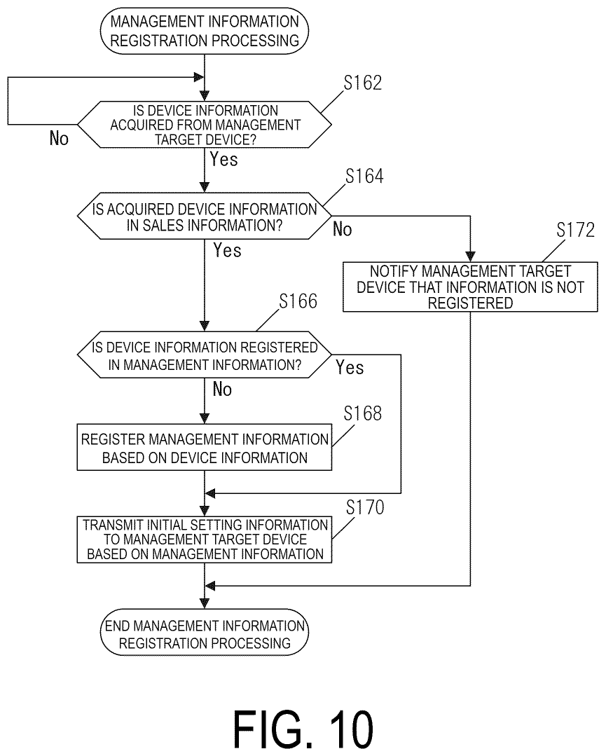

Hereinafter, a flow of processing in the present embodiment will be described. FIG. 7 is a diagram illustrating a flow of sales information display processing of the administrator device 20, and FIG. 8 is a diagram illustrating a flow of sales information registration processing of the management device 10. In addition, FIG. 9 is a diagram illustrating a flow of initial setting processing of the image forming apparatus 30, and FIG. 10 is a diagram illustrating a flow of management information registration processing of the management device 10.

The following processing will be described as being executed by the controllers (the controller 100, the controller 200, and the controller 300) of the respective devices (the management device 10, the administrator device 20, and the image forming apparatus 30); however, each configuration illustrated in FIGS. 4A and 4B or FIGS. 5A and 5B may execute the processing of each step.

In the present embodiment, the image forming apparatus 30 is connected to the management device 10 without the terminal device 40. Here, the terminal device 40 may perform, for example, processing of connecting to the management device 10 instead of the image forming apparatus 30.

### 1. 4. 1 Flow of Sales Information Display Processing

First, the controller 200 transmits the sales update information stored in the sales update information storage area 2110 to the management device 10 (S102). Then, the controller 200 determines whether the device information unregistered in the management information of the management device 10 transmitted from the management device 10 by processing S130 is acquired, and displays the unregistered device information on the display 240 in a case where the unregistered device information is acquired from the management device 10 (S104; Yes→S106). On the other hand, in a case where unregistered device information is not acquired from the management device 10, the controller 200 ends the processing as it is (S104; No).

### 1. 4. 2 Flow of Sales Information Registration Processing

First, the controller 100 determines whether the sales update information transmitted by the processing S102 is acquired from the administrator device 20 until the sales update information is acquired from the administrator device 20 (S122; No). In a case where the sales update information is acquired from the administrator device 20, the controller 100 determines whether there is a change between the sales information and the sales update information (S122; Yes→S124). At this time, for example, the controller 100 may determine whether there is a change between the device information (for example, a serial number, a model name, or the like) that can identify at least the management target device and the customer information (tenant information, group information, or the like) of the purchaser, and may ignore additional information such as a registration state.

In a case where there is a change between the sales information and the sales update information, the controller 100 reflects, in the sales information, for example, a change in the device information that can identify the management target device acquired from the sales update information and the customer information of the purchaser (S124; Yes→S126). Here, in a case where the device information on the management target device is not stored in the sales information before reflection, the controller 100 adds the device information to the sales information as new device information and reflects the device information.

Next, the controller 100 determines whether there is unregistered device information in the sales information (S128). Here, as a method of determining whether the device information stored in the sales information is unregistered, in the present embodiment, the controller 100 determines device information of which the registration state stored in the sales information is unregistered as unregistered. On the other hand, even in a case where there is no item of the registration state in the sales information, for example, the controller 100 may determine the device information that is not stored in the management information among the device information stored in the sales information as the unregistered device information.

In a case where the controller 100 determines that there is unregistered device information, the controller 100 transmits the device information determined as the unregistered device information to the administrator device 20 (S128; Yes→S130). On the other hand, in a case where the controller 100 determines that there is no unregistered device information, the controller 100 ends the processing as it is (S128; No).

### 1. 4. 3 Flow of Initial Setting Processing

First, the controller 300 connects to the management device 10 via the common connection destination stored in the setting information, and transmits the device information stored in the setting information on the image forming apparatus 30 (S142). Next, the controller 300 determines whether there is a notification that the device information transmitted by the processing S172 is unregistered from the management device 10, and in a case where there is no notification (S144; No) and the initial setting information transmitted by the processing S170 is received from the management device 10 (S146; Yes), the controller 300 executes the initial setting processing based on the initial setting information and the management policy (S148). Here, the controller 300 may display, for example, information regarding the initial setting after the initial setting processing is completed.

On the other hand, in a case where an unregistered notification is received from the management device 10 (S144; Yes) or in a case where the initial setting information is not received from the management device 10 (S146; No), the controller 300 ends the processing.

### 1. 4. 4 Flow of Management Information Registration Processing

First, the controller 100 controller 100 determines waits until the device information is acquired transmitted from the management target device by the processing S142 is acquired (S162; No). In a case where the device information is acquired from the management target device, the controller 100 determines whether the acquired device information is included in the sales information (S162; Yes→S164).

Next, in a case where the acquired device information is included in the sales information, the controller 100 determines whether the device information has been registered in the management information (S164; Yes→S166). Subsequently, in a case where the device information is not registered in the management information, the controller 100 registers the management information based on the acquired device information (S166; No→S168). Here, the controller 100 may register, for example, the sales information stored in the sales information storage area 1130 in association with the management information stored in the management information storage area 1110.

Subsequently, the controller 100 transmits the initial setting information and the management policy from the management information DB 1120 to the image forming apparatus 30 as the management target device based on the management information (S170). The controller 100 performs the same processing in a case where the device information is already registered in the management information (S166; Yes). On the other hand, in a case where the acquired device information is not included in the sales information, the controller 100 notifies the image forming apparatus 30, which is the management target device, that the device information is not registered (S164; No→S172).

### 1. 5 Operation Examples

First, the operation of the administrator device 20 will be described. The administrator device 20 stores, in the storage 210, a new sold device list in which the sold image forming apparatus 30, the initial settings, and the management policy are stored in association with each other as sales update information. Here, the sales update information (new sold device list) may be generated by acquiring tenant information and the like from a core system or business system, such as an enterprise resource planning (ERP) system. The system administrator operates the administrator device 20 to connect to the management device 10 via the network (NW3). The system administrator transmits the sales update information from the administrator device 20 to the management device 10, and reflects the change point of the sales update information on the sales information of the management device 10 to store it.

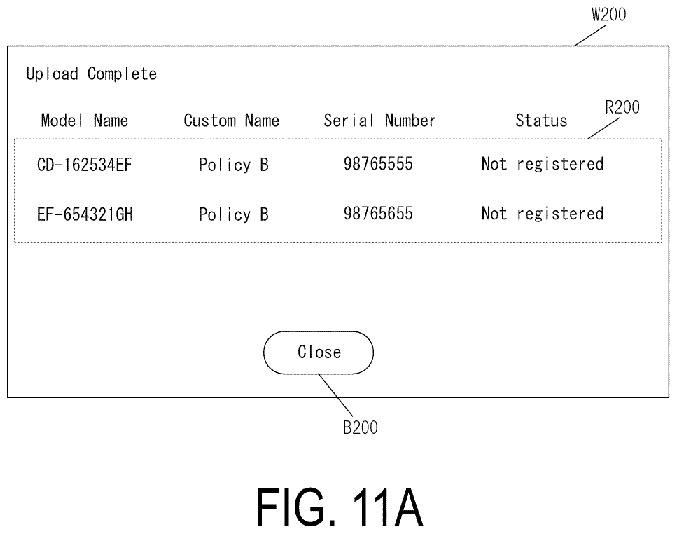

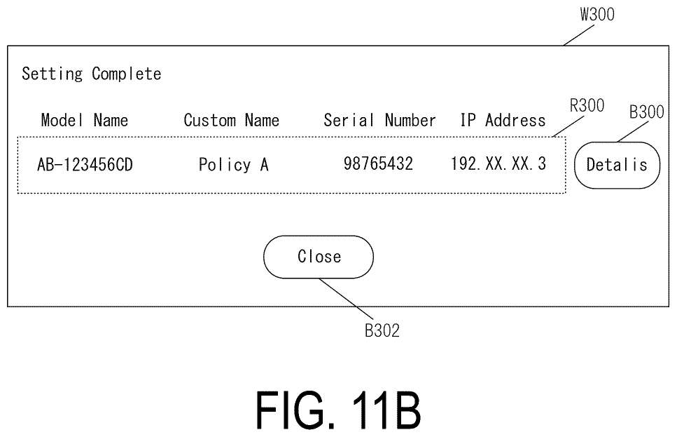

FIG. 11A is a diagram illustrating an example of the operation of the administrator device 20 in the present embodiment. FIG. 11A is a diagram illustrating an operation in which the administrator device 20 is connected to the management device 10, the sales information of the management device 10 is updated by the sales update information, and a list of management target devices that are not registered in the management device 10 is displayed on the display 240 of the administrator device 20 as a display screen.

In an area R200 of the display screen W200 of FIG. 11A, a list of device information that is not registered in the management information of the management device 10 including the newly registered device information is displayed. Further, a close button B200 for closing the display screen W200 is displayed on the display screen W200.

In this manner, the management device 10 can store the device information on the management target device (the image forming apparatus 30 in the present embodiment) that has been sold. In addition, by causing the cloud (system) to read the sold device list, for example, it is possible to detect the management target device that is not connected to the network yet and is not operating. Further, the display 240 of the administrator device 20 displays the sold management target devices in advance in a device list on a display screen such as a management screen, and when the status is a state such as not connected to the network, it is possible to give a notice that the user administrator has not performed network setting or the like of the management target device.

In addition, for example, when a system administrator registers device information on the sold image forming apparatus 30 in the sold device list (sales information) of the management device 10, the system administrator can store and set a URL for accessing the management device 10 as the common connection destination in the setting information of the image forming apparatus 30. Alternatively, the system administrator may perform hard coding at the time of factory shipment. In this way, by setting a common connection destination in advance, it is possible to install the management target device at any timing.

Next, the operation of the image forming apparatus 30 will be described. First, when the image forming apparatus 30 is connected to the network (NW1, NW3) by the user administrator, the image forming apparatus 30 accesses (connects to) the management device 10 (for example, a cloud system) as a common connection destination, based on the predetermined connection information (common connection destination information) that has been set. The management device 10 compares information (for example, device information) of the image forming apparatus 30 with the registered sold device list. In a case where the information on the image forming apparatus 30 is not present in the sold device list, the management device 10 does not register the image forming apparatus 30 as a management target device in the management information.

On the other hand, in a case where the information on the image forming apparatus 30 is present in the sold device list and the image forming apparatus 30 is not registered (unregistered) in the management information, the management device 10 automatically registers the image forming apparatus 30 in the corresponding tenant based on the information on the sold device list, for example. The management device 10 is connected to the image forming apparatus 30, and reflects the corresponding initial setting and management policy on the image forming apparatus 30, for example.

FIG. 11B is a diagram illustrating a display screen displayed on the display 340 of the image forming apparatus 30, the screen indicating the result in which the initial setting information was acquired from the management device 10 and the initial setting processing was completed as a result of the above operation. On the display screen W300 illustrated in FIG. 11B, an area R300 in which the device information on the image forming apparatus 30 for which the initial setting has been completed is displayed, a Detail button B300 for displaying the details, and a close button B302 for closing the display screen W300 are displayed. When the user administrator selects the Detail button B300, the controller 300 displays, for example, details of the initial setting applied to the image forming apparatus 30.

In addition, in a case where the information on the image forming apparatus 30 is present in the sold device list, the image forming apparatus 30 is registered in the management information, and the initial setting is completed, for example, a setting change reception screen is displayed on the image forming apparatus 30. In a case where the information on the image forming apparatus 30 is not present in the sold device list, the image forming apparatus 30 may display a display screen for warning the user administrator on the display 340.

As described above, in a case where the image forming apparatus 30 is connected to the common connection destination, the management device 10 compares the information with the sold device list (sales information), and performs registration when the information is listed up in the sold device list. By registering the device information in the system in advance, a sold device list is generated, and in a case where a connection is made from a common connection destination, the sold device list is referenced, and in a case where the image forming apparatus 30 is registered in the sold device list, the connected image forming apparatus 30 can be registered to the target tenant based on the information registered in advance. Since the sold device list is associated with the tenant, the tenant to be registered has already been confirmed when the sold device list is created, and also since the installation location and the like are determined in advance by the user or the installer, it is only necessary to connect the device to the network (NW1, NW2), and there is no need to perform work for connection to the management system at the time of installation, whereby it becomes possible to shorten or omit the installation work and installation time.

Further, settings for each user, such as the tenant of the registration destination of the image forming apparatus 30, initial settings, or management policies, can be set, for example, for each tenant or group, when the sold device list (sales information) is registered (read) in the management device 10. By setting the tenant of the registration destination, the initial settings, and the management policies in the sold device list, the user can unify the setting of the image forming apparatus 30 or set different settings for each installation location, and can manage the image forming apparatus 30 in more detail.

Furthermore, when creating the sold device list, it is possible to specify and register individual settings such as the registration destination, initial settings, and management policy for each device, for example, when registering the sold device list (sales information) in the management device 10. Accordingly, even more complex installation work and installation procedures can be automated. In the case of complex settings and procedures, the skills and proficiency of the worker (user administrator) who performs the work are required, and costs for installation and maintenance become necessary. If these can be set in advance and verified in advance in the system, it will become unnecessary for a skilled person to accompany the installation, allowing installation without specialized knowledge, and further cost reduction can be achieved.

In addition, the user can also automatically change the settings after the image forming apparatus 30 is connected to the management device 10, for example. As described above, since it becomes possible to change the settings of the management target device later, even if the management target device had been set to connect directly to the cloud (management system) before installation, for example, it is also possible to change the settings via the terminal device 40 after the connection. Accordingly, it becomes possible to easily change the settings to a connection form that better suits the user's environment and requirements.

When the individual connection destination can be input, the image forming apparatus 30 may connect to the common connection destination in a case where the individual connection destination is not input. For example, even if the user does not set the common connection destination, the user can omit the work of setting the common connection destination by connecting to the common connection destination stored in advance in the image forming apparatus 30.

### 1. 6 Effects, or the Like

In this way, by accessing the common connection destination without registering individual connection destinations in advance, for example, it becomes possible to implement the system registration at an arbitrary timing. Accordingly, since no work by the user administrator occurs at the time of installation, it becomes possible to easily register the device to be managed and to enable appropriate management.

Furthermore, by enabling the application of individual initial settings and management policies in conjunction with the registration into the management information, it becomes possible to implement reductions in user management cost, introduction cost, and initial installation cost of the service.

### 2. Modification Examples

The disclosure is not limited to the above-described embodiments, and various modifications are possible.

In other words, embodiments obtained by combining technical mechanisms appropriately changed without departing from the gist of the disclosure are also included in the technical scope.

Although the above-described embodiments have been separately described for convenience of description, the embodiments can be combined and executed within an allowable range. The right of any of the technologies described herein is intended to be acquired through amendment, divisional application, or the like.

The programs running on each device in the embodiments are programs for controlling a CPU or the like (programs for causing a computer to function) to implement the aforementioned functions in the embodiments. Information handled by these devices is temporarily accumulated in a transitory storage device (for example, a RAM) at the time of processing, is then stored in a storage device such as any of various ROMs or an HDD, and is read, corrected, and written by the CPU as needed.

The recording medium storing the programs may be any of a semiconductor medium (for example, a ROM, a non-volatile memory card, or the like), an optical recording medium or a magneto-optical recording medium (for example, a Digital Versatile Disc (DVD), a Compact Disc (CD), a Blu-ray (trade name) Disc (BD) or the like), a magnetic recording medium (for example, a magnetic tape, a flexible disk, or the like), and the like.

In a case where the programs are distributed to market, the programs can be stored and distributed in a portable recording medium, or can be transferred to a server computer connected via a network such as the Internet. In this case, it is a matter of course that the storage device of the server device is also included in the disclosure.

Instead of being stored in the device, the above-described data may be stored in an external device and called as appropriate. For example, the data may be stored in a network attached storage (NAS) or may be stored on a cloud.

It should be noted that the scope of the disclosure is not limited to the configurations explicitly described herein, and a combination of technologies disclosed herein is also included in the scope thereof. Configurations of the disclosure sought to be patented are set forth in the appended claims, but configurations not recited in the claims are not intended to be excluded from the technical scope.

In the above-described specification, the descriptions “in a case in which . . . ” and “when . . . ” are described as examples, and the configuration is not limited to the described contents. Configurations not indicated by the descriptions “in a case in which . . . ” and “when . . . ” are also disclosed to the extent that the configurations are obvious to a person skilled in the art, and the rights thereof are intended to be acquired.

The processing and the flow of data have been described herein with order, but the order thereof is not limited to the described order. For example, a configuration in which processing is partly removed or the order is rearranged is also disclosed, and the right thereof is intended to be acquired.

Although the functions described in the embodiments are described as being performed in the respective devices, the functions may be implemented in one device or using an external server.

In addition, each functional block or various features of the device used in the above-described embodiments may be implemented or executed by an electric circuit such as, for example, an integrated circuit or a plurality of integrated circuits. An electrical circuit designed to perform the functions described herein may include a general-purpose processor, a digital signal processor (DSP), an application specific integrated circuit (ASIC), a field programmable gate array (FPGA) or other programmable logic device, discrete gate or transistor logic, discrete hardware components, or a combination thereof. The general-purpose processor may be a microprocessor or may be a processor, controller, microcontroller, or state machine of the related art. The electric circuit described above may be configured of a digital circuit or may be configured of an analog circuit. Further, when an integrated circuit technology for replacement into a current integrated circuit emerges with the development of semiconductor technology, a new integrated circuit based on the technology may also be used in one or more aspects of the disclosure.

1. A device management system, comprising:
one or a plurality of first devices; and
a second device that manages the one or the plurality of first devices, wherein
the first device transmits device information for identifying the first device to the second device via a common connection destination, and
the second device connects to the first device when the device information is stored.

2. The device management system according to claim 1, further comprising
a third device, wherein
the second device
acquires first management information from the third device,
stores second management information including customer information for connecting to the first device,
determines, when the first management information includes the device information on the first device, whether the device information is not registered in the second management information,
registers, when determining that the device information is not registered in the second management information, the device information in the second management information, and
transmits setting information based on the customer information included in the second management information to the first device, and
the first device displays the setting information.

3. The device management system according to claim 2,
wherein the second device
compares the device information included in the first management information with the device information included in the second management information, and
transmits, in a case where there is a difference in the device information, the difference in the device information to the third device, and the third device displays the device information.

4. The device management system according to claim 2, wherein
the second device transmits, when registering the device information in the second management information, management policy information to the first device having transmitted the device information, and
the first device applies the management policy information.

5. The device management system according to claim 2, wherein
the first management information is the device information on sold devices, and
the second management information includes setting information and operation information on the first device.

6. The device management system according to claim 1,
wherein, when the second device stores the device information for identifying the first device, the common connection destination is set in the first device.

7. The device management system according to claim 2,
wherein, when the first device has not set a connection destination to which the device information for identifying the first device is to be transmitted, the first device transmits the device information to the common connection destination.

8. An image forming apparatus, comprising:
a communicator that transmits device information to a management device as a common connection destination;
an acquirer that acquires setting information and management policy information based on customer information from the management device; and
an initial setting executor that executes an initial setting, based on the setting information and the management policy information.

9. A device management method for a system,
the system including
one or a plurality of first devices, and
a second device that manages the one or the plurality of first devices,
the method comprising:
a transmission step in which the first device transmits device information for identifying the first device to the second device via a common connection destination; and
a connection step in which the second device connects to the first device when the device information is stored.
